(19) United States
(12) Patent Application Publication
(10) Pub. No.: US 2008/0289749 A1
(43) Pub. Date: Nov. 27, 2008

(54) Method for Manufacturing a Diagnostic Test Strip

(76) Inventors: Steven C. Charlton, Osceola, IN (US); Sung-Kwon Jung, Granger, IN (US)

Correspondence Address: NIXON PEABODY LLP, 161 N. CLARK STREET, 48TH FLOOR, CHICAGO, IL, 60601, US

(21) Appl. No.: 11/579,558

(22) PCT Filed: May 13, 2005
(86) PCT No.: PCT/US2005/16723

§ 371 Date: Nov. 3, 2006

Related U.S. Application Data
(60) Provisional application No. 60/571,046, filed on May 14, 2004.

(51) Int. Cl. B32B 37/02

(52) U.S. Cl. 156/247

(57) ABSTRACT

A method for manufacturing a diagnostic test strip is disclosed according to one embodiment. The method includes the acts of providing an application sheet having a plurality of adhesive dots thereon, providing a first substrate layer having at least one feature located thereon, and providing a second substrate layer. The method further including the acts of transferring at least one of the plurality of adhesive dots located on the application sheet to the first substrate layer, aligning the first substrate layer with the second substrate layer, and attaching the first substrate layer and the second substrate layer using the transferred adhesive dots, wherein the attaching of the first and second substrate layers is performed without any additional alignment.

### CROSS-REFERENCE TO RELATED APPLICATION

This application claims priority to Application No. 60/571,046 filed on May 14, 2004, which is incorporated by reference in its entirety.

### FIELD OF THE INVENTION

The present invention relates generally to diagnostic instruments and, more particularly, to a method for manufacturing a diagnostic test strip for use in determining the concentration of an analyte in a liquid sample.

### BACKGROUND OF THE INVENTION

Test strips (e.g., biosensors) containing reagents are often used in assays for determining the analyte concentration in a fluid sample. Testing and self-testing for the concentration of glucose in blood is a common use for test strips. Typical diabetic users test themselves between one to four times daily. Each test requires that a new test sensor be used and, thus, cost of the individual test sensors is important to the users.

Test sensors can be manufactured by attaching multiple layers together to form a single test sensor. In the manufacturing of multi-layered test sensors, typically an adhesive is applied between the layers to ensure that the layers remain securely attached. These attached layers are then punched to create the features (e.g., capillary channels, reaction areas, electrodes, test elements, etc.) required for the test sensor to function as desired. However, the punching of the attached layers causes the adhesive to build-up around the punching or slitting dies. This build-up requires the manufacturing apparatus be shut down periodically to remove the accumulated adhesive around the dies, which incurs significant costs and time. Additionally, alignment of the adhesive with the layers to be attached generally requires precise alignment of the adhesive with the first layer and then alignment of a first layer and adhesive with a second layer.

Test sensors can also be manufactured by attaching embossed layers together to form a single test sensor. Typically, one side of an adhesive layer is attached to an embossed base layer. A third layer is then applied to the other side of the adhesive layer, opposite the base layer. This requires the manufacturer to first align the embossed base layer with the adhesive layer to avoid the covering of the embossed features by the adhesive layer. Then the manufacturer must align the third layer with the newly formed base-adhesive layered structure. This procedure is then repeated with additional layers are added to the structure.

Thus, a need exists for a new method of manufacturing a test sensor.

### SUMMARY OF THE INVENTION

A method for manufacturing a diagnostic test strip is disclosed according to one embodiment of the present invention. The method includes the acts of printing a plurality of adhesive dots on a first surface of a provided application sheet. A feature is fashioned into a face at least one of a plurality of substrate layers. The application sheet is then applied to one of the plurality of substrate layers such that the adhesive dots are located between the application sheet and the first substrate layer. At least one adhesive dot is transferred from the application sheet to the first substrate layer by removing the application sheet from the first substrate layer. The first substrate layer is then aligned with another of the plurality of substrate layers. The second substrate layer is applied to the first substrate layer, such that the transferred adhesive dots are in contact with both the first substrate layer and the second substrate layer.

A method for manufacturing a diagnostic test strip is disclosed according to another embodiment of the present invention. The method includes the acts of applying an adhesive to a plurality of different areas on a first surface of a provided application sheet. A feature is fashioned into a face at least one of a plurality of substrate layers. The feature creates an uppermost surface and a lowermost surface on the face of the first substrate layer. The application sheet is then applied to the first substrate layer such that the adhesive is located between the first surface of the application sheet and the face of the first substrate layer. At least one of the plurality of different areas of the adhesive is in contact with the uppermost surface of the face of the first substrate layer. The adhesive is transferred by removing the application sheet from the first substrate layer after at least one of the plurality of different areas of the adhesive is in contact with the uppermost surface of the face of the first substrate layer, such that the adhesive in contact with the uppermost surface of the face of the first substrate layer remains. A second plurality of substrate layers is then aligned with the first substrate layer and the second substrate layer is applied to the first substrate layer. The adhesive remaining on the uppermost surface of the face of the first substrate layer contacts both the first substrate layer and the second substrate layer.

A method for manufacturing a diagnostic test strip is disclosed according to another embodiment of the present invention. The method includes the acts of providing an application sheet having a plurality of adhesive dots thereon, providing a first substrate layer having at least one feature located thereon, and providing a second substrate layer. The method further including the acts of transferring at least one of the plurality of adhesive dots located on the application sheet to the first substrate layer, aligning the first substrate layer with the second substrate layer, and attaching the first substrate layer and the second substrate layer using the transferred adhesive dots, wherein the attaching of the first and second substrate layers is performed without any additional alignment.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE DRAWINGS

FIG. 1a is an exploded side view of an application sheet and a substrate layer according to one embodiment of the present invention.

FIG. 1b is a side view of the application sheet of FIG. 1a removably attached to the substrate layer of FIG. 1a.

FIG. 1c is a side view of the substrate layer of FIG. 1b after the application sheet has been removed.

FIG. 2 is an exploded side view of an application sheet and a substrate layer according to one embodiment of the present invention.

FIG. 2b is a side view of the application sheet of FIG. 2a removably attached to the substrate layer of FIG. 2a.

FIG. 2c is a side view of the substrate layer of FIG. 2b after the application sheet has been removed.

FIG. 3 is an exploded perspective view of an example of a test sensor capable of being manufactured according to one embodiment of the present invention.

FIG. 4 is a flowchart of a method for adhering a first substrate layer to a second substrate layer according to one embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents and alternatives falling within the spirit and scope of the invention as defined by the appended claims.

### DESCRIPTION OF ILLUSTRATED EMBODIMENTS

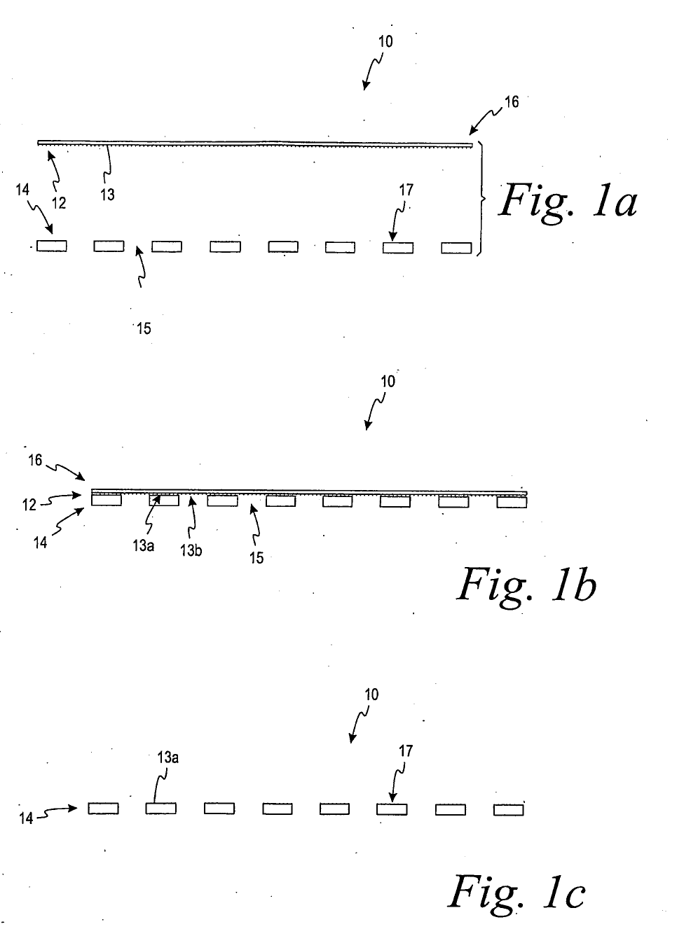

Turning now to the drawings and initially to FIGS. 1a-c, a process 10 for applying an adhesive 12 to a substrate layer 14 is shown according to one embodiment of the present invention. The substrate layer 14 has a face 17 where punched areas 15 have been formed by a prior process. The adhesive 12 is originally attached to an application sheet 16 having the adhesive 12 located in separate and distinct areas. The application sheet 16 may be constructed of a silicon-treated substrate, which allows for the easy removal of the adhesive 12 from the application sheet 16. The adhesive 12 applied to the application sheet 16 is a transferable pressure-sensitive adhesive.

As shown in FIG. 1a, the adhesive 12 is applied to the application sheet 16 to form a plurality of adhesive dots 13. The adhesive dots 13 are applied to the application sheet 16, for example, by printing the desired pattern thereon. In an embodiment where the adhesive dots 13 are printed onto the application sheet 16, the adhesive 12 may be, for example, a commercially-available adhesive, such as the dot matrix adhesive sold by Landerink, Inc. of Belmont, Mich. Though smaller adhesive dots 13 are desirable according to certain embodiments of the present invention, the size of the dots can be adjusted to be larger or smaller. According to one embodiment of the invention, the adhesive dots 13 are about 300 microns in diameter. The adhesive dots 13 may be formed in a variety of shapes, including but not limited to, circles, ovals, squares, rectangles, triangles, or other polygonal and non-polygonal shapes.

In FIG. 1b, the application sheet 16 has been applied to the substrate layer 14 by applying pressure between the application sheet 16 and the substrate layer 14. As illustrated in FIG. 1b, certain adhesive dots 13a are located between and in contact with both the application sheet 16 and a face 17 of the substrate layer 14. At the same time, other adhesive dots 13b are located in the punched areas 15 and do not contact the face 17 of the substrate layer 14. Upon removing the application sheet 16 from the substrate layer 14, the adhesive dots 13a previously in contact with the face 17 of the substrate layer 14 remain thereon, as shown in FIG. 1c. The adhesive dots 13a remain on the face of the substrate layer 14 due to the higher adhesion forces between the adhesive 12 and the face 17 of the substrate layer 14 than between the adhesive 12 and the application sheet 16.

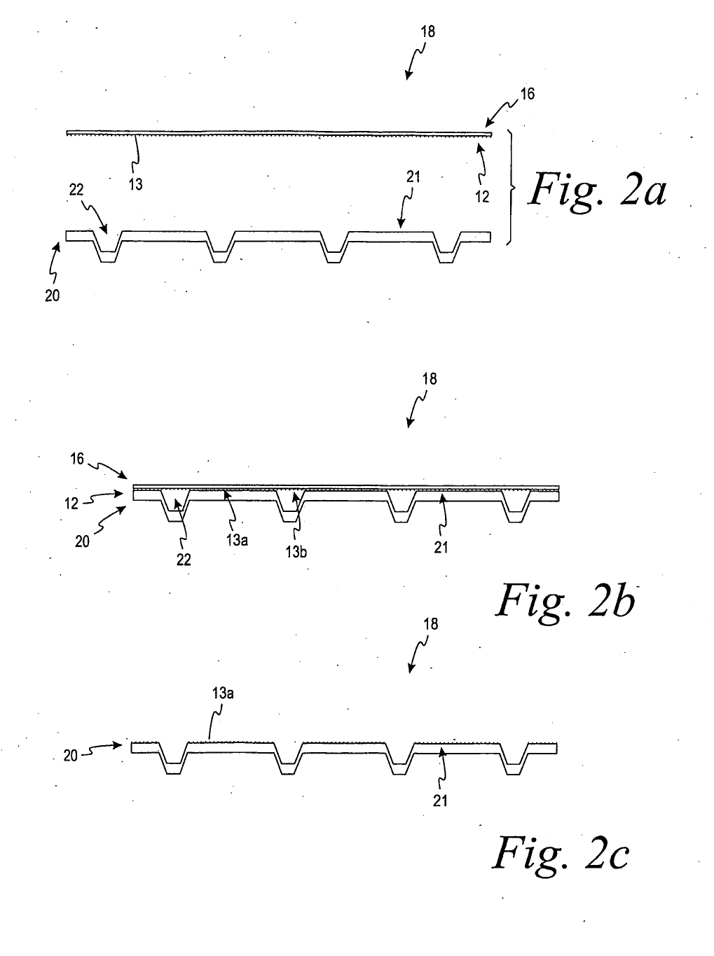

Referring now to FIGS. 2a-c, a process 18 for applying an adhesive 12 to a substrate layer 20 is shown according to another embodiment of the present invention. The face 21 of the substrate layer 20 has embossed areas 22, which have been formed by a prior process. As described above in FIGS. 1a-c, the application sheet 16 is applied to the face 21 of the substrate layer 20, as shown in FIG. 2b. The adhesive dots 13a are located between and in contact with both the application sheet 16 and the face 21 of the substrate layer 20, while other adhesive dots 13b are located in the embossed areas 22 and do not contact the face 17 of the substrate layer 20. Upon removing the application sheet 16 from the substrate layer 20, the adhesive dots 13a previously in contact with the face 21 of the substrate layer 20 remain on the face 21, as can be seen in FIG. 2c.

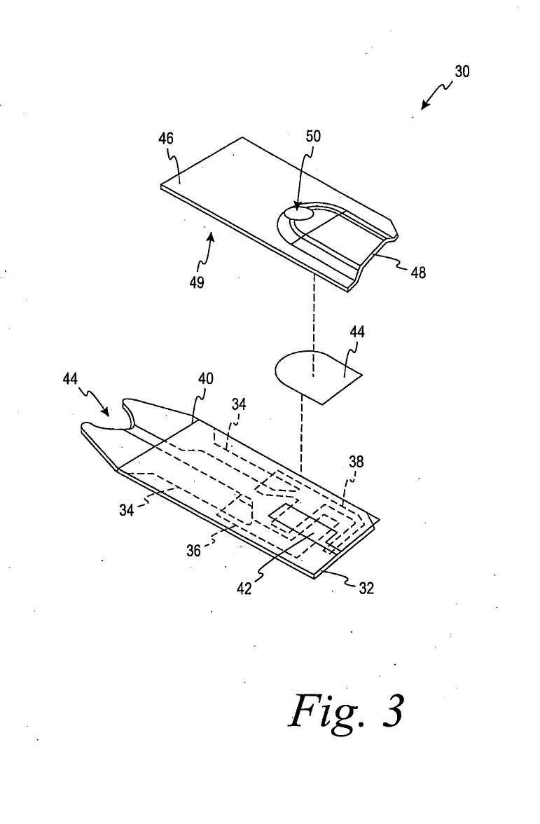

Referring to FIG. 3, an example of an electrochemical test strip 30 is shown that is capable of being manufactured according to one embodiment of the present invention. The electrochemical test strip 30 is described in greater detail in U.S. Pat. No. 6,531,040 B1 (“Electrochemical-Sensor Design”), which is incorporated herein by reference in its entirety. The test strip 30 may be used to determine the analyte concentration in a test fluid. The test strip 30 has a base 32 that is printed with various inks to form a conductive element 34, which is overcoated with a working electrode 36 and a counter electrode 38. The base is then overcoated with a dielectric layer 40 that contains an opening 42 that determines the extent to which the working 36 and counter 38 electrodes are exposed to the test fluid. A reaction layer 44 overcoats the dielectric layer 40. The dielectric layer 40 is printed with a predetermined pattern designed to leave a desired surface of the electrodes 36,38 exposed to the reaction layer 44 when it is printed over the dielectric layer 40. Finally, the base 32 is attached to a lid 46. The lid 46 is provided with an embossed concaved space 48 on a lower side 49 of the lid 46. The lid 46 is further provided with a venting hole 50.

The lid 46 and base 32 are then sealed together by, for example, utilizing an adhesive to form the electrochemical test strip 30. The application sheet 16 (FIGS. 1-2) is applied to the lower side 49 of the lid 46 by applying a slight pressure to the application sheet 16. As described with respect to FIGS. 1-2, the adhesive dots 13 will make contact with the flat, non-embossed regions of the lid 46. Thus, the adhesive 12 is not in contact with the concaved space 48 or the venting hole 50. Upon removal of the application sheet 16, the adhesive dots 13 that were in contact with the non-embossed portions of the lid 46 remain on the lid 46. The lid 46, with the adhesive dots 13 applied, is then aligned with the base 32 and the lid 46, which are attached by applying a slight pressure. The adhesive dots 13 fuse the base 32 to the lid 46 to create the electrochemical test strip 30.

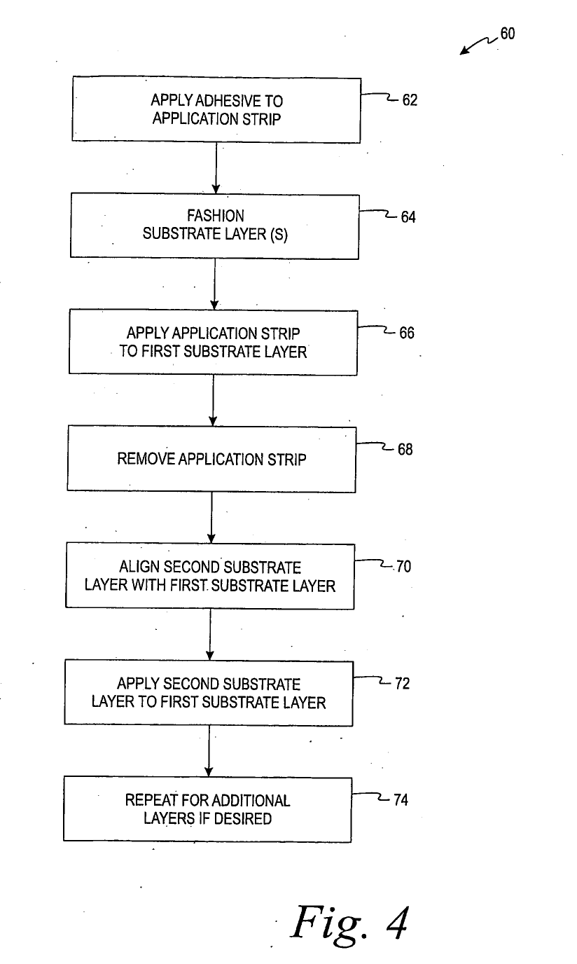

FIG. 4 is a flow diagram illustrating a method 60 of adhering a first substrate layer to a second substrate layer, according to one embodiment of the present invention. At step 62, the adhesive 12 is applied to the application sheet 16 to form adhesive dots 13 (FIGS. 1-2). At step 64, at least a first substrate layer is fashioned by being punched or embossed to create the desired features thereupon. A plurality of substrate layers may be fashioned at step 64 to form the particular test strip being manufactured. After the desired features have been fashioned on the substrate layer(s), the application sheet 16 is applied to the first substrate layer at step 66. Pressure is applied to the application sheet 16 to ensure that the adhesive dots 13 are in contact with the uppermost surfaces of the first substrate layer. Once the adhesive dots 13 have contacted the uppermost surfaces, the application sheet 16 is removed, at step 68, while the adhesive dots 13 in contact with the substrate surfaces remain.

After the adhesive dots 13 have been applied to the first substrate layer, a second substrate layer is aligned with the first layer at step 70. The second substrate layer is then applied to the first substrate layer, at step 72, and pressure is applied to ensure that the adhesive dots 13 are in contact with both the first and second substrate layers. Steps 64-74 may be repeated as many times as are necessary to attach further layers to the first, second, and/or additional substrate layers.

The method illustrated above has been described according to one embodiment with the desired features being fashioned into the various substrate layers prior to applying an adhesive to the first substrate layer. According to other embodiments of the present invention, however, the individual layers may be fashioned at any time prior to attachment, including after the adhesive has been applied to the first substrate layer, the second substrate layer, etc.

As can be seen from the above embodiments, the use of the application sheet 16 containing adhesive dots 13 allows the adhesive-free substrate to be punched or embossed. Thus, preventing or inhibiting the punch die or embossing machinery from becoming coated and/or contaminated by any adhesive. Further, utilizing the application sheet 16 and adhesive dots 13 allows the adhesive-free first substrate layer and the adhesive-free second substrate layer to be attached to one another without the need for aligning an additional adhesive layer.

The above invention has been further illustrated in connection with a particular electrochemical test strip. However, the invention is not limited to this particular type of test strip. The present invention may be utilized in connection with other embossed or punched test strips including, but not limited to, electrochemical and optical sensors in which two or more structures are adhered to each other.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents and alternatives falling within the spirit and scope of the invention as defined by the appended claims.

1. A method for manufacturing a test strip comprising the acts of providing an application sheet having a first surface; printing a plurality of adhesive dots on the first surface of the application sheet; providing a plurality of substrate layers having at least one face; fashioning at least one feature onto a first of the plurality of substrate layers, applying the application sheet to the first substrate layer, the adhesive dots being located between the first surface of the application sheet and the first substrate layer; transferring at least one adhesive dot by removing the application sheet from the first substrate layer; aligning a second of the plurality of substrate layers with the first substrate layer; and applying the second substrate layer to the first substrate layer, such that the transferred adhesive dots are in contact with both the first substrate layer and the second substrate layer.

2. The method of claim 1 further comprising the act of applying a silicon coating to the first surface of the application sheet prior to printing the plurality of adhesive dots on the first surface of the application sheet.

3. The method of claim 1, wherein the act of fashioning at least one feature is performed by punching the first substrate layer.

4. The method of claim 1, wherein the act of fashioning at least one feature is performed by embossing the first substrate layer.

5. The method of claim 1, wherein the act of printing a plurality of adhesive dots on the first surface of the application sheet occurs after the fashioning of at least one feature onto the first substrate layer.

6. The method of claim 1, wherein the plurality of adhesive dots is printed with glue.

7. The method of claim 1, wherein the manufactured test strip is an electrochemical test strip.

8. The method of claim 1, wherein the manufactured test strip is an optical test strip.

9. A method for manufacturing a test strip comprising the acts of providing an application sheet having a first surface; applying an adhesive to a plurality of different areas on the first surface of the application sheet; providing a plurality of substrate layers adapted to form the test strip, the plurality of substrate layers having at least one face; fashioning at least one feature into a first of the plurality of substrate layers, wherein the at least one feature creates an uppermost surface and a lowermost surface on the face of the first substrate layer; applying the application sheet to the first substrate layer, the adhesive being located between the first surface of the application sheet and the face of the first substrate layer, at least one of the plurality of different areas of the adhesive being in contact with the uppermost surface of the face of the first substrate layer; transferring the adhesive by removing the application sheet from the first substrate layer after at least one of the plurality of different areas of the adhesive is in contact with the uppermost surface of the face of the first substrate layer, such that the adhesive in contact with the uppermost surface of the face of the first substrate layer remains; aligning a second of the plurality of substrate layers with the first substrate layer; and applying the second substrate layer to the first substrate layer, the adhesive remaining on the uppermost surface of the face of the first substrate layer being in contact with both the first substrate layer and the second substrate layer.

10. The method of claim 9, wherein the act of applying an adhesive to the plurality of different areas on the first surface of the application sheet is performed by printing the adhesive onto the first surface of the application sheet.

11. The method of claim 9 further comprising the act of applying a silicon coating to the first surface of the application sheet prior to applying the adhesive to the plurality of different areas on the first surface of the application sheet.

12. The method of claim 9, wherein the adhesive applied to the first surface of the application sheet is glue.

13. The method of claim 9, wherein the manufactured test strip is an electrochemical test strip.

14. The method of claim 9, wherein the manufactured test strip is an optical test strip.

15. A method for manufacturing a test strip comprising the acts of providing an application sheet having a plurality of adhesive dots thereon; providing a first substrate layer having at least one feature located thereon; providing a second substrate layer;
transferring at least one of the plurality of adhesive dots located on the application sheet to the first substrate layer; aligning the first substrate layer with the second substrate layer; attaching the first substrate layer and the second substrate layer using the transferred adhesive dots, wherein the attaching of the first and second substrate layers is performed without any additional alignment.

16. The method of claim 15 wherein the act of transferring the plurality of adhesive dots is performed by applying the application sheet to the first substrate layer, such that the plurality of adhesive dots are located between the application sheet and the first substrate layer, then removing the application sheet from the first substrate layer, such that at least one of the plurality of adhesive dots remains on the first substrate layer.

17. The method of claim 15 wherein the at least one feature of the first substrate layer is fashioned by punching.

18. The method of claim 15 wherein the at least one feature of the first substrate layer is fashioned by embossing.

19. The method of claim 15, wherein the plurality of adhesive dots is glue dots.

20. The method of claim 15 wherein the provided application sheet is a silicon treated application sheet.

21. The method of claim 15, wherein the manufactured test strip is an electrochemical test strip.

22. The method of claim 15, wherein the manufactured test strip is an optical test strip.
